(19) United States
(12) Patent Application Publication
(10) Pub. No.: US 2016/0369563 A1
(43) Pub. Date: Dec. 22, 2016

(54) LADDER PAD

(71) Applicants: JEREMY ADCOCK, WILLIAMSTON, MI (US); DENTON L. JACKSON, III, COLDWATER, MS (US); KEITH MURPHREE, ENID, MS (US)

(72) Inventors: JEREMY ADCOCK, WILLIAMSTON, MI (US); DENTON L. JACKSON, III, COLDWATER, MS (US); KEITH MURPHREE, ENID, MS (US)

(21) Appl. No.: 14/745,452

(22) Filed: Jun. 21, 2015

(51) Int. Cl. E06C 7/46; E06C 7/48

(52) U.S. Cl. CPC E06C 7/46; E06C 7/48

(57) ABSTRACT

The Ladder Pad relates but, not limited, to U.S Class 182/107 in the field of safety device for ground-supported ladder. The invention provides ladder rail wells in a pad with an attached anti-kick-out bar which the rails are captured against and the ladder is strapped down against the pad by a ratchet strap. This assemble is further held in place on the ground by ground pins inserted through the pad into the substrate it is placed upon. And if ground pins are not applicable there is antiskid material attached under the ladder pad. For further stabilization arms may be provided which extend from a stored position and also have apertures for ground pins on their outer ends for further ground grip. The invention may also be practiced in a trench situation by assembly and lowering it into the trench.

### CROSS-REFERENCE TO RELATED APPLICATIONS

None

### BACKGROUND OF THE INVENTION

This invention relates but, not limited, to U.S Class 182/107 in the field of safety device for ground-supported ladder.

In prior art many approaches have been made toward providing more stable support for ladders leaned against an object to provide above ground access to workers. Such as the following U.S. patents:

U.S. Pat. No. 53,374 1894 Wilkins—Described an attached anti-skid fold down ground claw ladder attachment;
U.S. Pat. No. 776,446 1904 Williamson—Discloses a pad with foot wells, set screw to hold the ladder rails and a central ground auger to secure the pad to the ground;
U.S. Pat. No. 1,710,026 1929 McCormick—Discloses a frame which may be adjusted to serve as a scaffold floor support or inverted and attached to stabilize a ladder including a chain and hook to secure either configuration;
U.S. Pat. No. 2,523,535 1949 Little—Discloses an adjustable anchor, I describe as a tow bar type, having a single point twist claw rung attach and detent adjustable length and tail ground anchor pin. It is notably shown bracing the ladder from the climbing side;
U.S. Pat. No. 4,007,807 1977 Pogwizd—Discloses a rail attached ground bayonet on each rail and a chain and pin system;
U.S. Pat. No. 5,865,268 1999 Finneran—Discloses a rail attached ground bayonet on each side;
U.S. Pat. No. 5,890,560 1999 Sloop—Discloses a tow bar type V with two rung attach points on the top of the V with variable set screw adjustable length and a pole wrap strap on the point of the V;
U.S. Pat. No. 6,955,243 2005 Huff—Discloses a dual spade ground claw with a strap to pull and hold the ladder;
U.S. Pat. No. 8,464,834 2013 Blazin et al—Discloses a formed V rod with a rung hook on each end and a coil formed at the apex to receive a ground pin and a storage hook;
U.S. Pat. No. 8,607,932 2013 Cooper et al—Discloses struts with ground pins;
2014/0216850 2014 application Marley et al—Discloses a reversible pad with grip lugs, spikes, or rubber pad; and
U.S. Pat. No. 4,941,547 1990 Livick—Describes a two ladder scaffold with a leveling pad and ground spike with a ground spike on the un raised ladder.

### SUMMARY OF THE INVENTION

For many workmen access to the subject of their efforts requires the worker to climb a ladder especially but, certainly not limited to, lineman. Often the ground surrounding the work area may be “soft” and not even uniformly soft allowing one or both ladder rails to sink and become uneven or perhaps worse, uneven support not being apparent. And when surrounding area is hard or slopes away from the object the risk of the bottom of the ladder rails slipping also presents hazards. Unattached ladders are leaned against another object to provide stability. The lean angle also provides for the worker to lean toward the work which biases the worker's own center of gravity forward of normal for standing allowing the worker to use their arms as they lean on the ladder.

The force vectors created by the worker putting their body weight on the rungs include the positive force at the top of the ladder to hold it against the object but has the opposite effect at the bottom of the ladder attempting to push the rails away from the object. This may be easily demonstrated by leaning the ladder too shallowly against a smooth wall and as a weight is advanced up the rungs to the point that the top begins to slide down the wall, the ladder bottom will tend to slide away from the wall. Many ladders include feet that pivot in order to present more area to the surface it is positioned upon and accommodate different Lean angles and usually have cleats to resist the outward force. The described hazards are even greater for ladders without pivoting feet. Another negative factor is when weight is moved to one side of the ladder a force vector(s) attempting tip or twist the ladder is created causing uneven weighting on the ladder rails and just before tipping sideways all of the weight may be on one rail further aggravating rail sinking or skidding.

The current invention ladder pad (1) assembly addresses the cited problems by providing an increased area on which the ground load is exerted, pinning to the ground, larger area of skid resistance, an antiskid pad (19), stability arms (10) that create a wider base to resist rail sinking and/or side tipping and ladder rail wells (18), and anti-kick-out bar (2) for capture of the ladder to the ladder pad against the anti-kick-out bar (2). The invention accommodates ladders (20) both pivot foot (21) and non-footed ladders by the rails being placed into rail wells (18). However, footed ladders will have the advantage of the pivot foot (21) being more securely captured under the anti-kick-out bar (2). In the preferred embodiment the ladder pad is a polymer molding. Other materials may be used. The rail wells (18) are formed in the ladder pad (1). The anti-kick-out bar (2) is also polymer and attached to the ladder pad by fasteners. Ground pins (7) are provided and the ladder pad accommodates storing the pins in ground pin storage apertures (9). The ground pins (7) may have grips to assist the user to remove them. The ladder pad (1) has ground pin apertures (8) for insertion of the pins through the ladder pad (1). Stability Arms (10) may be provided with a hinge plate (11) having an affixed arm rotation pin with arm position aperture (13) and arm pin (12) on the ladder pad (1). The arms would swing out from a storage position to provide out riggers to give even more side stability. While the arm pin (12) and arm storage aperture and extension aperture would provide positive position holding. A ratchet strap (3) with hook (5) is included and ratchet strap attach bracket (4) which is used to capture the ladder (20) to the ladder pad (1) by threading the strap over a lower rung (22) and attaching it to the ladder pad (1) via a ratchet strap hook eye (17) on the opposite side of the ladder (20). Elastic strap eyes (16) are also provided to attach and an elastic strap (23) or another ratchet strap to provide more force to hold the ladder against the anti-kick-out bar (2). And a carry loop (6) handle is provided.

The invention is used by temporarily positioning the ladder as it will be used often on a utility pole (24). If the stability arms (10) are to be used they are swung out to extended position. The rails are then lifted and the ladder pad (1) is positioned under them. If the ground is un-level set the ladder (20) and ladder pad (1) aside and level the area. The bottoms of the rails are then placed in the rail wells (18) and moved against the anti-kick-out bar (2) and the ladder (20) and ladder pad (1) assembly is set in final position. Elastic strap eyes (16) are provided on each side of the anti-kick-out bar (2) to receive hook ends of an elastic strap (23), bungee cord, truck tarp strap and others, with the elastic strap (23) warped around the back of the ladder (20) and if present over its pivot feet (21). If used the ground pins (7) are then inserted through the ground pin apertures (8) and inserted into the substrate upon which the ladder pad (1) is resting. The ratchet strap is then brought over a lower rung (22) the ratchet strap hook (5) attached to the ratchet strap hook eye (17) and tension the strap. If the area is sloped the worker may “lasso” the ladder pad (1) to the object ladder (20) is leaned against by threading a tie off means, preferably tension-able, around the object and through the carry loop. The worker may now ascend the ladder and tie off the ladder top with a tie off securing means (25) including but, not limited to, rope, adjustable strap or clamp. The order of assembly/attachment may be varied to suit the situation. The assembly may also be place in a trench for worker decent and egress. Tear down is reverse of the set up except obvious steps. In a trench situation the first worker to descend may move the assembly to level the ground and insert the ground pins. If needed a lanyard may be looped onto the ground pins to facilitate removal from the upper ground level after the last worker climbs out.

### BRIEF DESCRIPTION OF THE DRAWINGS

In the drawings which illustrate the preferred embodiment of the invention:

FIG. 1 is an upper perspective drawing illustrating the ladder pad (1).

FIG. 2 is a lower perspective drawing illustrating the lower side of ladder pad (1).

FIG. 3 is an upper perspective drawing illustrating of the ladder pad (1) also showing its stability arms (10) extended.

FIG. 4 is an upper perspective drawing illustrating showing the ladder pad (1) and a ladder (20) being installed.

FIG. 5 is an upper perspective side drawing showing the ladder pad (1) with its ratchet strap (3) looped over a lower rung (22) of the ladder (20) and cinched.

FIG. 6 is an upper perspective drawing showing the ladder pad (1) and ladder (20) assembly with a tie off securing means (25) rope in place on a utility pole (24).

### DETAILED DESCRIPTION

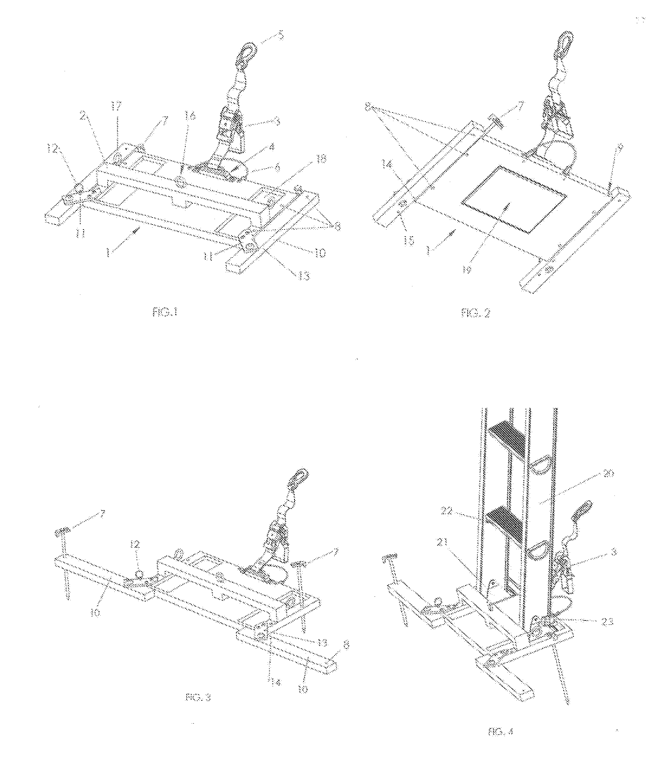

FIG. 1 is an upper perspective drawing illustrating the ladder pad showing: ladder pad (1), anti-kick-out bar (2), ratchet strap (3), ratchet strap attach bracket (4), ratchet strap hook (5), carry loop (6), ground pin (7), ground pin aperture(s) (8), ground pin storage apertures (9) (not shown in this view), stability arm (10) shown in folded position, hinge plate (11), arm pin (12), arm position aperture (13), arm storage aperture (14) (not shown in this view), arm extension aperture (15) (not shown in this view), elastic strap eye (16), ratchet strap hook eye (17) and rail wells (18).

FIG. 2 is a lower perspective drawing illustrating the lower side of ladder pad (1), ground pin (7) in its stored position, ground pin apertures (8), ground pin storage aperture (9), arm storage aperture (14), arm extension aperture (15) and antiskid pad (19).

FIG. 3 is an upper perspective drawing illustrating all the elements of FIG. 1 also showing stability arms (10) extended, arm pin (12) in arm position aperture (13), arm storage aperture (14) and ground pins (7) inserted in ground pin apertures (8). Arm pin (12) is removed and stability arm (10) is extended and arm pin (12) is inserted into arm position aperture (13), arm extension aperture (15) (not visible), and arm storage aperture (14). Upon final placement to secure a ladder ground pin(s) (7) is inserted into ground pin aperture(s) (8) and into the substrate.

FIG. 4 is an upper perspective drawing illustrating all the elements of FIG. 1 also showing ladder (20) with pivot foot (21) in rail well (18) and lower rung (22).

FIG. 5 is an upper perspective side drawing showing elastic strap (23) hooked into elastic strap eyes (16) to urge ladder (20) against anti-kick-out bar (2) to ladder pad (1) for maneuvering the assembly however this not always essential. Ratchet strap (3) is looped over lower rung (22) or a higher rung and ratchet strap hook (5) is latched into ratchet strap hook eye (17) and then ratchet strap (3) is tensioned. The ladder (20) and ladder pad (1) assembly may then be moved as a unit. Upon final placement ground pin(s) (7) are pushed through aperture(s) (8) and into the substrate on which the assembly is placed.

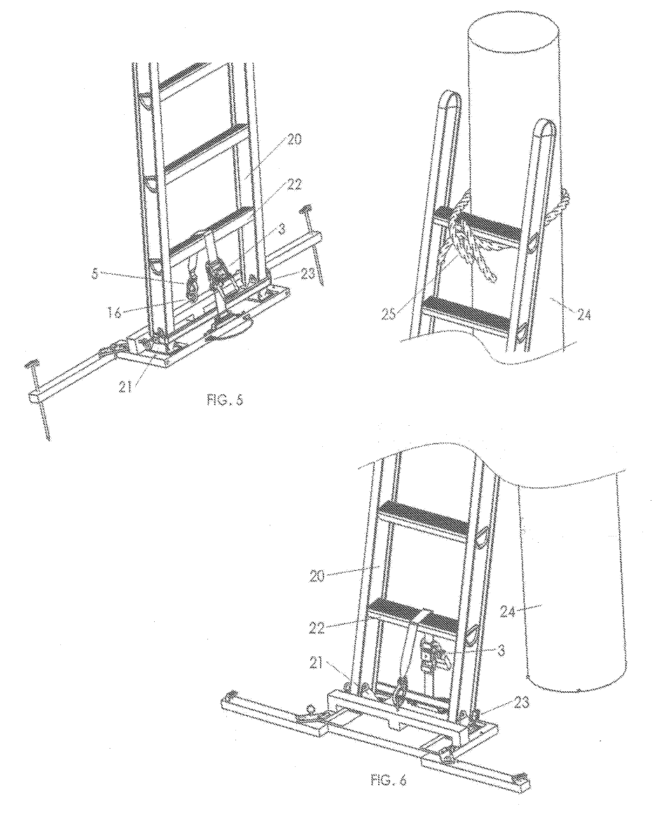

FIG. 6 is an upper perspective drawing illustrating the assembled ladder pad (1) and ladder (20) with ratchet strap (3) over lower rung (22) and ratchet strap hook (5) engaged in ratchet strap hook eye (17) and tensioned with ladder (20) leaned against pole (24) the worker would then climb the ladder and tie off securing means (25) rope securing ladder (20)'s upper rung to the pole (24) and then begin work.

The method would then be reversed to remove the ladder (20) and ladder pad (1). The embodiments described and shown are intended to be illustrative and not limiting the claims. Those skilled in the art can envision equivalent alternate embodiments to practice what is taught by this application.

END

What is claimed:

1. A ladder stabilization system comprising: a ladder pad (1) having a length, width and thickness its upper surface defining two substantially rectangular rail wells (18) whose length is parallel to each other on opposite sides of said pad and their depth is less than the thickness of said pad;
An anti-kick-out bar (2) having a length, width and height comprising a substantially rectilinear shape having a length approximating the width of said pad (1), its upper region surface being planar, its lower region defining two rectangular notches companionate to said pad wells and further defining at least two bar to pad fastener apertures;
at least two anti-kick-out bar to pad common fasteners;
Said anti-kick-out bar (2) fastened to said pad's (1) upper surface with said notch areas proximal and aligned with said rail wells (18) having its forward side behind but proximal to the forward edges of said rail wells (18);
said anti-kick-out bar (2) further having elastic strap eyes (16) fastened to each end centrally located being an eye bolt and fasteners or eye lag screw whose shank is substantially parallel to the bar's length;
said anti-kick-out bar (2) further defining a strap hook eye aperture on each end;
a ratchet strap (3) as commonly known having a length of strap fixed to the ratchet with its opposite end attached to said ladder pad (1) via a ratchet strap attach bracket (4) fastened on its upper surface to the rear of said pad centered between said rail wells (18), the adjustable strap having a ratchet strap hook (5) on its end opposite the end wound into the ratchet;
a strap hook eye (17) being an eye bolt and fasteners or an eye lag screw;
said ladder pad (1) also defining a strap hook eye aperture being substantially centered on its width and forward of said rail wells;
at least two ground pins (7) having a length with an expanded proximal head and a tapered to point distal end;
said ladder pad (1) also defining at least 4 ground pin apertures (8) being substantially perpendicular to said upper surface and proximal to each corner;
said ladder pad (1) also defining ground pin storage apertures (9) whose diameter slide-ably receives the length of said ground pin (7) length being located on the rear of the pad and substantially parallel to its length and positioned to not enter said rail wells (18);
an antiskid pad (19) affixed to the lower surface of said ladder pad (1) being made of a compliant material which tends to grip on other surfaces;
a carry loop (6) and fasteners, said carry loop fastened to the rear of said pad;
an elastic strap (23) with hooks on each end as commonly known;
a ladder (20) optimally having pivot feet (21);
a tie off securing means (25);
the user selecting the area the base of a ladder will be positioned, leveling said area if needed, said ladder pad (1) is positioned on said area;
said ladder (20) is positioned with its feet in said rail wells (18);
said elastic strap (23) first end is hooked into a first elastic strap eye (16) pulled behind said ladder (20) and, if present, above said pivot feet (21) and its second end is hooked into the second elastic strap eye (16);
said adjustable strap of said ratchet strap (3) is pulled over a lower rung (22) of said ladder (20) and ratchet strap hook (5) engaged in said strap hook eye (17) and said ratchet (3) is tensioned;
if the application dictates the ladder and pad may now be lowered into a trench;
if the area the pad is set on is malleable the ground pins (7) are withdrawn from said ground pin storage apertures (9) and inserted through said ground pin apertures (8) and into the substrate of said area;
if said system is utilized above ground and the object said ladder will be leaned on can be reached around, often a utility pole (24), the user ascends said ladder and secures the upper end of said ladder with said tie off securing means (25);
if said system is utilized below ground level, the user will secure the upper end of said ladder and descend said ladder and install said ground pins (7) per the ground pin step above; and
upon completion of their task the user completes the reverse of the afore mentioned steps.

2. The ladder stabilization system of claim 1 further comprising stability arms (10); said arms having a length width and thickness;
at least an upper hinge plate (11);
said hinge plate (11) further comprising an affixed arm rotation pin and arm position aperture (13);
said stability arms (10) each defining a rotation pin aperture, arm storage aperture (14), arm extension aperture (15) being proximal to a first end and a ground pin aperture (8) proximal its second end;
said hinge plate (11) fastened to each forward corners of said ladder pad (1);
said stability arms (10) each defining an rotation pin aperture, arm storage aperture (14), arm extension aperture (15) being proximal to a first end positioned to accommodate said stability arms (10) folding along the side of said ladder pad (1) and to rotate arms opposite each other substantially 90 degrees, extending outward from said ladder pad (1);
said stability arm (10) further defining a ground pin aperture (8) proximal its second end;
said stability arms (10) mounted to said hinge plate (11);
an arm pin (12) companionate to said arm position (13), storage (14) and extension (15) apertures;
the user having accomplished the afore mentioned steps of claim 1 further;
Removes the arm pin (12) from said arm storage aperture (14) of hinge pate (11), rotates said stability arms (10) to their extended position and reinserts said arm pin (12) into said arm position aperture (13) and said arm extension aperture (15);
if needed removes said ground pin(s) (7) and inserts them through said ground pin aperture (8) on said stability arm(s) (10); and
upon completion of their task the user reverses the steps back to storage position and continues to complete the reverse of the afore mentioned steps of claim 1.

3. A ladder stabilization system comprising: a ladder pad (1) having a length, width and thickness its upper surface defining two substantially rectangular rail wells (18) whose length is parallel to each other on opposite sides of said ladder pad (1) and their depth is less than the thickness of said ladder pad (1);
An anti-kick-out bar (2) having a length, width and height comprising a substantially rectilinear shape having a length approximating the width of said ladder pad (1), its upper region surface being planar, its lower region defining two rectangular notches companionate to said pad rail wells (18);
Said anti-kick-out bar (2) fastened to said ladder pad's (1) upper surface with said notch areas proximal and aligned with said rail wells (18) having its forward side behind but proximal to the forward edges of said rail wells (18);
said anti-kick-out bar (2) further having elastic strap eyes (16) fastened to each end centrally located being an eye bolt and fasteners or eye lag screw whose shank is substantially parallel to the bar's length;
said anti-kick-out bar (2) further defining a strap hook eye aperture on each end;
a ratchet strap (3) as commonly known having a length of strap fixed to the ratchet with its opposite end attached to said ladder pad (1) via a ratchet strap attach bracket (4) fastened on its upper surface to the rear of said pad centered between said rail wells (18), the adjustable strap having a ratchet strap hook (5) on its end opposite the end wound into the ratchet;
a strap hook eye (17) being an eye bolt and fasteners or an eye lag screw;
said ladder pad (1) also defining a strap hook eye aperture being substantially centered on its width and forward of said rail wells;
at least two ground pins (7) having a length with an expanded proximal head and a tapered to point distal end;
said ladder pad (1) also defining at least 4 ground pin apertures (8) being substantially perpendicular to said upper surface and proximal to each corner;
said ladder pad (1) also defining ground pin storage apertures (9) whose diameter slide-ably receives the length of said ground pin (7) length being located on the rear of the pad and substantially parallel to its length and positioned to not enter said rail wells (18);
an antiskid pad (19) affixed to the lower surface of said ladder pad (1) being made of a compliant material which tends to grip on other surfaces;
a carry loop (6) and fasteners, said carry loop fastened to the rear of said pad;
an elastic strap (23) with hooks on each end as commonly known;
a ladder (20) optimally having pivot feet (21);
a tie off securing means (25);
stability arms (10); said stability arms (10) having a length width and thickness;
at least an upper hinge plate (11);
said hinge plate (11) fastened to each forward corners of said ladder pad (1) further comprising an arm rotation pin and defining arm position aperture (13);
said stability arms (10) each defining an rotation pin aperture, arm storage aperture (14), arm extension aperture (15) being proximal to a first end positioned to accommodate said stability arms (10) folding along the side of said ladder pad (1) and to rotate arms opposite each other substantially 90 degrees, extending outward from said ladder pad (1);
said stability arm (10) further defining a ground pin aperture (8) proximal its second end;
said stability arms (10) mounted to said hinge plate (11);
an arm pin (12) companionate to said arm position (13), storage (14) and extension (15) apertures;
the user selecting the area the base of said ladder (20) will be positioned, leveling said area if needed;
said ladder pad (1) is positioned on said area;
said ladder (20) is positioned with its feet in said rail wells (18);
said elastic strap (23) first end is hooked into a first said elastic strap eye (16) pulled behind said ladder (20) and, if present, above said pivot feet (21) and its second end is hooked into the second said elastic strap eye (16);
said adjustable strap of said ratchet strap (3) pulled over a lower rung (22) of said ladder (20) and said ratchet strap hook (5) engaged in said strap hook eye (17) and said ratchet is tensioned;
if the application dictates the ladder and pad assembly may now be lowered into a trench;
otherwise the user removes said arm pin (12) from said arm storage aperture (14) and hinge pate (11), rotates said stability arms (10) to their extended position and reinserts said arm pin (12) into said arm position aperture (13) and said arm extension aperture (15);
if the area the pad is set on is malleable said ground pins (7) are withdrawn from said ground pin storage apertures (9) and inserted through said ground pin apertures (8) and into the substrate of said area;
if said system is utilized above ground and the object said ladder (20) will be leaned on can be reached around, often a utility pole (24), the user ascends said ladder (20) and secures the upper end of said ladder (20) with said tie off securing means (25);
if said system is utilized below ground level, the user will secure the upper end of said ladder (20) and descend said ladder (20) and install said ground pins (7) per the ground pin step above; and
upon completion of their task the user completes the reverse of the afore mentioned steps.
